(19) United States
(12) Patent Application Publication
(10) Pub. No.: US 2004/0061266 A1
(43) Pub. Date: Apr. 1, 2004

(54) Adjustable-length compression spring

(75) Inventors: Hans-Werner Riel, Neumarkt (DE); Rainer Knapp, Deining (DE); Gerhard Wunderling, Pegnitz (DE); Stefan Richter, Ahomtal (DE)

Correspondence Address: BROWDY AND NEIMARK, P.L.L.C., 624 NINTH STREET, NW, SUITE 300, WASHINGTON, DC, 20001-5303, US

(73) Assignee: SUSPA COMPART GMBH, Sulzbach-Rosenberg (DE)

(21) Appl. No.: 10/668,183

(22) Filed: Sep. 24, 2003

(30) Foreign Application Priority Data
Sep. 21, 2002 (DE) 102 44 671.7

(51) Int. Cl. F16F 5/00

(52) U.S. Cl. 267/124; 267/64.12

(57) ABSTRACT

A compression spring comprises a casing with a piston that is mounted on a piston rod being disposed for displacement therein. Two sectional casing chambers are provided in the casing, which are filled with pressure fluid and at least one of which is defined by the piston. A controllable first valve interconnects the sectional casing chambers in an open position and blocks the compression spring in a shut-off position. By way of an additional automatic valve between the sectional casing chambers, the compression spring, even when blocked, can be adjusted in the piston-rod push-out direction by a force being applied that is comparable to the push-out force that works in the push-out direction by the pressure of the pressure fluid. This provides for greater flexibility in use of the compression spring.

### BACKGROUND OF THE INVENTION

1. Field of the Invention

The invention relates to an adjustable-length compression spring, comprising a casing, which is filled with a free-flowing pressure fluid and has a central longitudinal axis; a guide and seal unit, which closes a first end of the casing; a piston rod, which has an outer end and is sealingly extended through the guide and seal unit out of the first end of the casing; a piston, which is connected to the piston rod and sealingly guided in the casing; a pressure-fluid-filled first sectional casing chamber, which is unilaterally defined by the piston; an energy accumulator for exercising pressure on the pressure fluid; a pressure-fluid-filled second sectional casing chamber, which is connectable to the first sectional casing chamber; and a controllable valve for interconnection of the sectional casing chambers by an actuation/overflow assembly, the valve having a valve pin, which is movable from outside the casing into an open position of the controllable valve and into a shut-off position.

2. Background Art

Blockable compression springs in the form of gas springs are known in large numbers. For example, so-called double-tube gas springs have been known, in which two tubes are disposed concentrically one within the other, between them defining an annular channel. Sectional casing chambers are provided on both sides of the piston; they can be connected to each other via the annular channel and a valve that is disposed at one end of the casing. Adjustable-length gas springs of the generic type are described for example in U.S. Pat. No. 3,656,593.

Adjustable-length gas springs are known, in which the valve is disposed in the piston, the gas springs being actuated by a valve actuation rod that is disposed inside the hollow piston rod. Gas springs of the species are for example known from U.S. Pat. No. 4,949,941. In these gas springs, the sectional casing chambers can also be filled with hydraulic oil; in this case, the compressed gas is in a compressed-gas chamber which is allocated to the closed end of the casing and separated from the adjacent sectional casing chamber by a sliding piston which is guided on, and sealed towards, the inside wall of the casing.

EP 1 101 972 A2 teaches an extension gas spring that has a casing with a piston rod concentrically guided therein. Mounted on the piston rod is a piston which is guided in, and sealed towards, the casing, dividing an oil chamber into two sectional oil chambers. Furthermore, a valve is available for interconnection of the sectional oil chambers, having a valve pin which is controllable from outside the casing and which, upon insertion in a valve-open direction in the direction of a central longitudinal axis, is moved into a valve-open position and, by means of a restoring spring, is moved counter to the valve-open direction into a shut-off position. The extension gas spring blocks in this closing position. An extension gas spring, which the piston rod is led into, is integrated in the casing contiguous to the oil chamber. A pressure control valve of the type of a check valve is additionally provided in the piston that divides the sectional oil chambers; it comprises a channel that passes through the piston and interconnects the sectional oil chambers and is closed on one side by a spring-loaded sealing washer. Upon extreme overload, beyond admissible, between the piston rod and the casing, this pressure control valve opens, releasing the spring blockage. It is the purpose of this measure to avoid any damages to the gas spring or parts linked thereto in the case of overload. The piston rod cannot be moved relative to the casing when the gas spring is blocked.

With a view to flexibility of application, the known lockable springs still offer possibilities of improvement. In particular, there are cases that demand for movability of the piston rod relative to the casing even when the compression spring is blocked.

### SUMMARY OF THE INVENTION

It is an object of the invention to embody a compression spring of the type mentioned at the outset for more flexible use, it being desirable that the piston rod is movable relative to the casing even when the compression spring is blocked.

According to the invention, this object is attained in an automatic valve for interconnection of the sectional casing chambers by an automatic overflow connection, the automatic valve comprising a valve element, which is pre-loaded in a shut-off position such that, in the valve-pin shut-off position of the controllable valve, opening the automatic valve into an open position takes place only when an overcoming force F₁ works between the piston rod and the casing in a piston-rod push-out direction, with −2F₂<F₁<2F₂ applying to a relationship between the overcoming force F₁ and a push-out force F₂ which, by the pressure of the pressure fluid, works between the piston rod and the casing in the sectional casing chambers in a piston-rod push-out direction in the open position of the valve pin of the controllable valve.

All the known lockable springs have in common that the blocking effect can be lifted only by extreme overload which by far exceeds the force exercised by the energy accumulator on the piston rod in a direction of extension thereof. This force—hereinafter referred to as extension force—is defined as the force by which to extend the piston rod when it is positioned within the casing at a distance of 5 mm before the stop in the direction of extension and when the controllable valve is open so that the two sectional casing chambers are connected to each other.

According to the invention, it has been found that the additional automatic valve enables the blocking of the compression spring to be overcome, even when the controllable valve is shut off, by a force being applied for overcoming that is comparable to the force of extension exercised by the energy accumulator on the piston rod in the direction of extension thereof. This considerably augments the possibilities of application of the compression spring. When the force of overcoming is approximately the same as the force of extension, and maximally twice the force of extension, blocking of the compression spring can be overcome by adjusted overcoming force in accordance with the respective field of application of the spring so that, in these cases, the blockage of the compression spring need not be released by actuation of the controllable valve. This increases the ease and convenience of operating the compression spring.

The overcoming force can be regulated by predetermined pre-load of the automatic valve. Apart from the force of extension, additional load on the piston rod must be considered, this additional load acting counter to the direction of piston-rod extension. Depending on the order of magnitude of this load, advantageous ranges of overcoming force are defined as follows: the force F₁ to F₂ relationship may be 0<F₁<F₂, in particular 0<F₁<0.5F₂, preferably 0<F₁<0.1F₂ or F₁=0; the force F₁ to F₂ relationship may be −F₂<F₁<0, in particular −0.5F₂<F₁<0, preferably −0.1F₂<F₁<0.

Corresponding compression springs are fit for use in adjustable backrests for example of vehicle seats, with the compression spring being designed for the relieved backrest, even when blocked, to return automatically into an upright initial position. The force of overcoming then corresponds to a force resulting from the force of extension in the piston-rod push-out direction and a load that acts in the opposite direction even upon relief, for instance due to the weight of the backrest, which will act on the piston rod even when the backrest is relieved. Another possibility of application of a compression spring that is extendible even when blocked resides for example in table-board height adjustment. In this case, the pre-load of the automatic valve is selected such that minor additional overcoming force will be sufficient for extending the compression spring even when blocked, the compression spring being pre-loaded counter to the direction of piston rod extension by the weight of the table board.

For backrest adjustment, the force of overcoming may be set such that the backrest can be moved into the upright position by additional pressure in the direction of piston-rod extension even when the compression spring is blocked by the controllable valve in the shut-off position.

Excellent sealing properties are provided when the valve element of the automatic valve is a composite body with a substrate layer that is at least unilaterally coated with a non-metal layer; when the substrate layer of the valve element is made of metal; and when the non-metal layer of the valve element is made of one of the group selected from plastic material and rubber. The valve element can be manufactured at a low cost and incorporated into the compression spring.

Pre-loading is easily feasible with the valve element of the automatic valve being an annular disk which is pre-loaded in the shut-off position.

Energy accumulators designed as a compressed-gas chamber and as a helical spring and a pressure fluid in the form of oil have proved successful, depending on the field of application.

An automatic overflow connection which comprises an overflow channel with a cylindrical pin inserted enables the damping effect of the adjustable-length compression spring to be finely tuned by way of the ranges of diameter of the overflow channel on the one hand and the cylindrical pin on the other and by way of the length of the cylindrical pin.

Further features, advantages and details of the invention will become apparent from the ensuing description of several exemplary embodiments, taken in conjunction with the drawing.

### BRIEF DESCRIPTION OF THE DRAWING

FIG. 1 is a longitudinal sectional view of a first embodiment of a compression spring;

FIG. 2 is a longitudinal sectional view, on a strongly enlarged scale as compared to FIG. 1, of the valves of the compression spring in the shut-off condition;

FIG. 3 is an illustration, similar to FIG. 1, of the compression spring with a shut-off blocking valve and an open automatic valve;

FIG. 4 is a longitudinal sectional view of a second embodiment of a compression spring;

FIG. 5 is a longitudinal sectional view of a third embodiment of a compression spring;

FIG. 6 is a longitudinal sectional view of a fourth embodiment of a compression spring; and

FIG. 7 is an illustration, similar to FIG. 2, of another embodiment of the compression spring.

### DESCRIPTION OF PREFERRED EMBODIMENTS

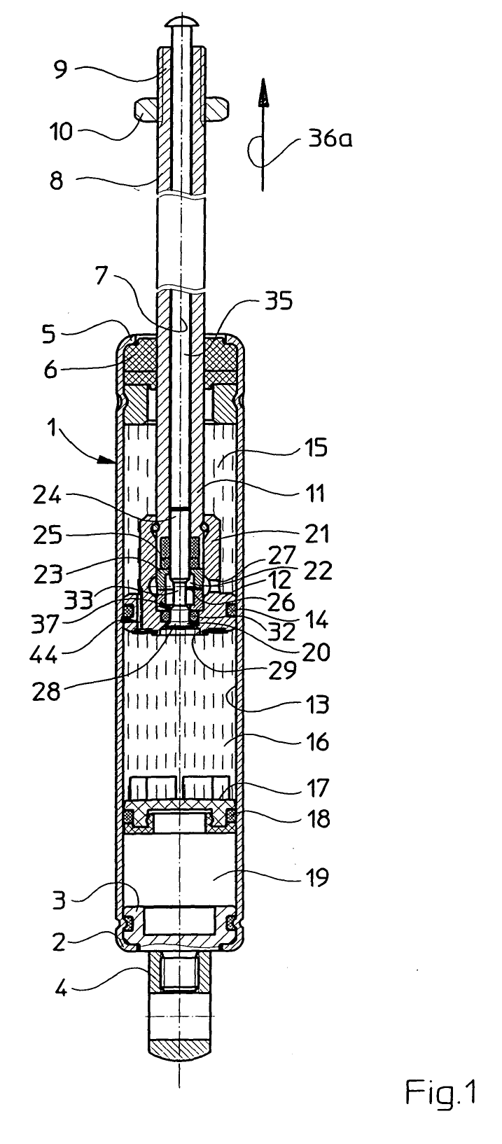

The first embodiment, seen in FIGS. 1 to 3, of a blockable, adjustable-length gas spring comprises a substantially cylindrical casing 1 in the form of a tube, one end 2 of which being sealed gastight by a bottom 3 on which is mounted a fastening element 4. An annular guide and seal unit 6 is fixed to the other end 5 of the casing 1 for fluid-tight sealing; the unit 6 serves for guiding and sealing a piston rod 8 which is displaceable in the casing 1 concentrically of the central longitudinal axis 7 thereof. Another fastening element 10 is mounted on the free end 9, outside the casing 1, of the piston rod 8.

A piston 12 is mounted on the end 1 1, inside the casing 1, of the piston rod 8; the piston 12 is guided on the inside wall 13 of the casing 1 and is made fluid-tight towards the wall 13 by the aid of a seal 14. The piston 12 divides the interior of the casing into a first sectional casing chamber 15, located between the piston 12 and the guide and seal unit 6, and a second sectional casing chamber 16 that faces away therefrom. The sectional casing chamber 16 is again defined by a sliding piston 17 which is guided for displacement on the inside wall 13 of the casing 1 and made gas- and fluid-tight towards the wall 13 by a seal 18. Disposed between the sliding piston 17 and the bottom 3 is a compressed-gas chamber 19 that serves as an energy accumulator, containing gas under pressure. The sectional casing chamber 15, 16 are filled with a fluid, for example hydraulic oil.

In the piston 12 provision is made for a blocking valve 20 by means of which to connect to, or separate from, each other the sectional casing chambers 15, 16. The blocking valve 20 comprises a valve body 21 which is located on the side of the piston 12 that is turned towards the seal and guide unit 6. Disposed in the hollow valve body 21 is a two-part bush 23 which defines an overflow chamber 22 and which a valve pin 24 passes through that is arranged and displaceable coaxially of the axis 7. The valve pin 24 is sealed outwards between the bush 23 and the hollow piston rod 8 by means of a seal 25. The overflow chamber 22 is permanently connected to the sectional casing chamber 15 by means of a throttling port 26 formed in the bush 23 and an overflow channel 27 formed in the valve body 21.

At its end turned towards the sectional casing chamber 16, the valve pin 24 has a valve disk 28 of two-step conical expansion, which is disposed inside the connecting aperture 29 of the valve 20 towards the sectional casing chamber 16.

A second conical wall 30, of greater diameter, of the valve disk 28 serves for defined motion of the valve pin 24 in the direction of extension thereof. To this end, this second conical wall 30 cooperates with an opposite surface 31 of the valve body 21. Between the two conical surfaces, the valve pin 24 has a cylindrical wall 31 a. This wall 31 a tightens by a seal 32 towards the valve body 21. The seal 32 is located in a circumferential groove formed by the valve body 21 and the bush 23.

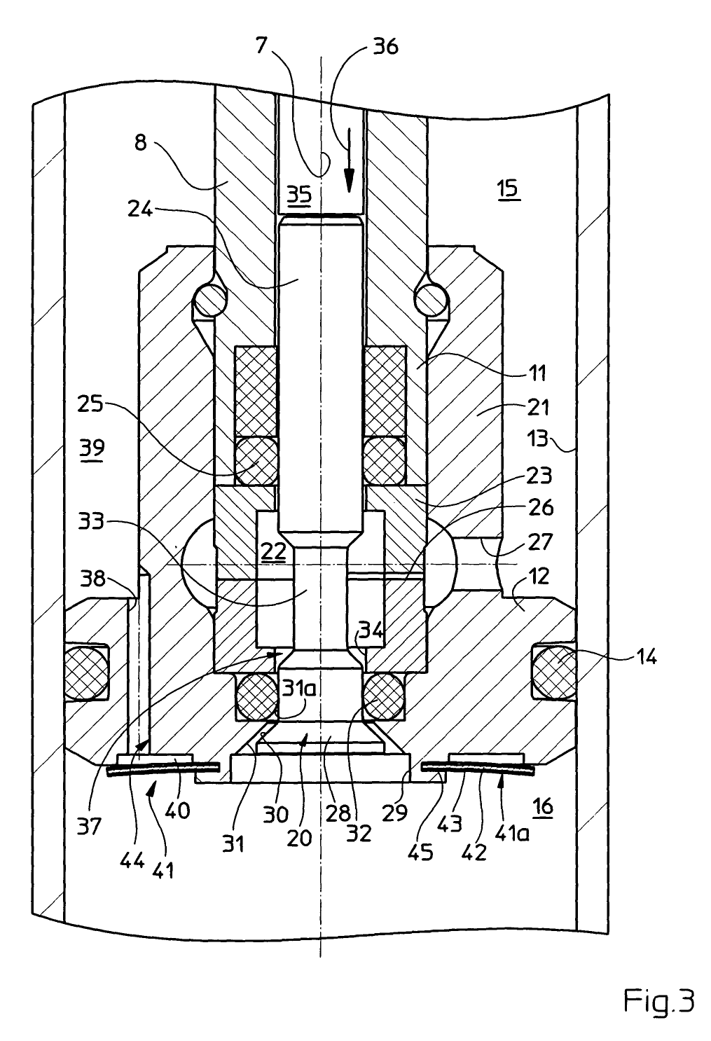

In the area between the overflow chamber 22 and the valve disk 28, the valve pin 24 has a tapered section 33, with an annular channel 34 that reaches as far as to the valve disk 28 being formed between the tapered section 33 and the neighboring parts, namely the bush 23, seal 32 and opposite surface 31. Disposed in the hollow piston rod 8 is a valve actuation rod 35 which is displaceable in the direction of the axis 7 and controllable from the end 11 by displacement, bearing against the valve pin 24. When, according to FIG. 3, this rod 35 is pushed into the piston rod 8 in the valve-open direction 36, then the valve pin 24 is moved from the shut-off position in a direction towards the sectional casing chamber 16 into a valve-open position. As a result, the sealing cylindrical wall 3 la of the valve disk 28 lifts off the seal 32, the tapered section 33 and the seal 32 now coinciding. In this way, the sectional casing chamber 15 is connected to the sectional casing chamber 16 via an actuation/overflow assembly 37 formed by the overflow channel 27, the throttling port 26, the overflow chamber 22, the channel 24 and the connecting aperture 29, and hydraulic oil can flow from the sectional casing chamber 16 to the sectional casing chamber 15 upon insertion of the piston rod 8 into the casing 1. This insertion takes place against the counterforce produced by the compressed gas in the compressed-gas chamber 19, with the sliding piston 17, upon this motion, being displaced in a direction towards the bottom 3, further compressing the gas.

If however the piston rod 8 is relieved when the valve is open, it is pushed out of the casing 1 by the force exercised by the compressed gas; the sliding piston 17 is moved away from the bottom 3. Consequently, the gas spring is a compression gas spring. When the actuation rod 35 is released, then the valve pin 24 is again pressed into the shut-off position by the pressure that works in the sectional casing chamber 16. The piston 12, together with the piston rod 8, is then hydraulically locked and blocked relative to the casing 1.

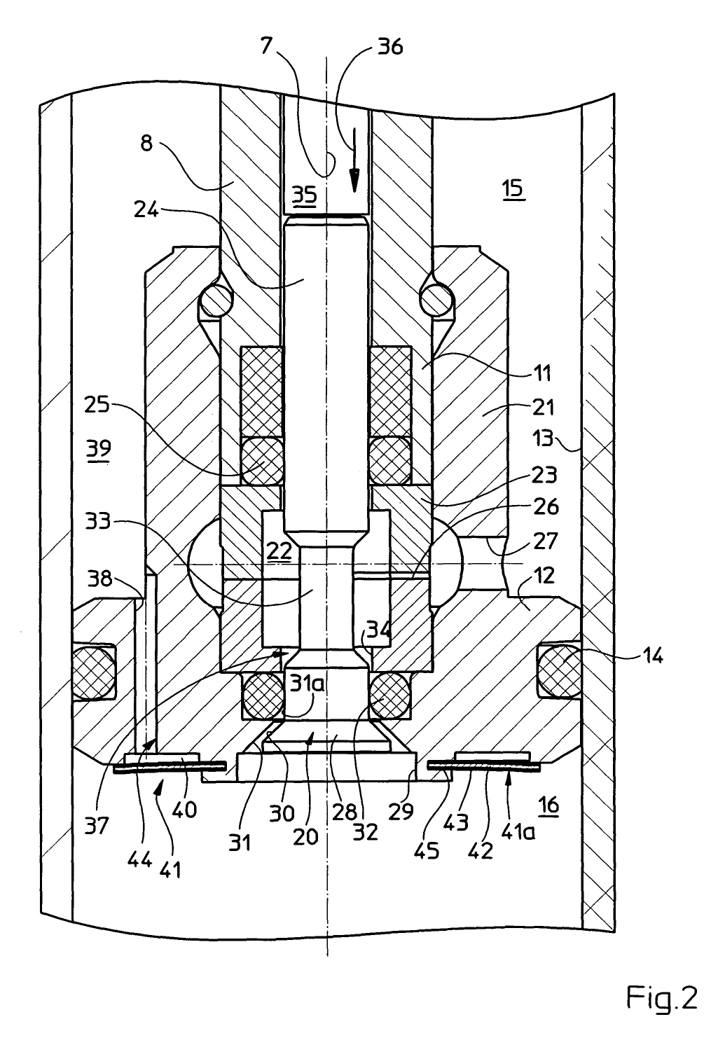

The two sectional casing chambers 15, 16 are additionally connected to each other via an overflow channel 38, which discharges into the first sectional casing chamber 15 via an annular sectional-casing-chamber segment 39 that externally surrounds the valve body 21. The overflow channel 38 discharges into the second sectional casing chamber 16 via a circumferential groove 40 which is formed in the valve body 21, encircling the connecting aperture 29 coaxially of the central longitudinal axis 7. In FIGS. 1 and 2, this circumferential groove 40 is closed by an automatic valve 41 in the form of an annular disk. The disk 41a, serving as a valve element, of the automatic valve 41 is a three-layer composite body. A sheet metal medial layer 42 is bilaterally coated with a plastic coating 43.

FIG. 3 illustrates the automatic valve 41 in the opened condition while the blocking valve 20 continues to be shut off. In this case, an automatic overflow connection 44 is produced between the sectional casing chambers 15, 16 via the overflow channel 38 and the circumferential groove 40.

In the position seen in FIGS. 1 and 2, the disk 41a of the automatic valve 41 is axially pre-stressed in the way of a saucer spring in the shut-off position, closing the circumferential groove 40 and thus the automatic overflow connection 44. This is accomplished by a groove 45, which is designed coaxially of the central longitudinal axis 7 around the connecting aperture 29 in the valve body 21 and receives the inward peripheral area of the disk 41a, being axially dislocated in the direction of the central longitudinal axis 7 as compared to the surface, resting on the valve body 21, of the free outward peripheral area of the disk 41a of the automatic valve so that the disk 41a of the automatic valve 41 is slightly bent in the shut-off position. For this pre-stress to be adjusted, for example the thickness of the medial layer 42 may vary.

When the piston rod 8 is relieved in the shut-off position of the blocking valve 20, the blockage of the piston 12 and the pre-load of the compression spring via the compressed-gas chamber 19 results in an extension force that acts on the piston 12 and is composed of a force, which works in the direction of extension of the piston 12 and results from the pressure in the second sectional casing chamber 16, and an opposed force, which works counter to the direction of extension of the piston 12 and results from the pressure in the first sectional casing chamber 15. The ratio of these two forces that produce the resultant corresponds to the area ratio of the sectional casing chambers 15, 16 in the vicinity of the piston 12. Since this are in the vicinity of the piston 12 is smaller on the side turned towards the first sectional casing chamber 15 than on the side turned towards the second sectional casing chamber 16, a higher pressure is available in the first sectional casing chamber 15 by reason of the pre-load produced by the compressed-gas chamber 19 than there is in the second sectional casing chamber 16. As a result, a pressure builds up in the automatic overflow connection 44 that acts counter to the pre-load of the disk 41a of the automatic valve 41 in the shut-off position. Depending on the pre-load of the disk 41a, the automatic valve 41 will open upon certain excess pressure in the overflow channel 38 as compared to the pressure in the second sectional casing 15. This excess pressure is produced by a force that acts on the piston rod 8 for overcoming the compression-spring blockage even though the blocking valve 20 is shut off.

Depending on the degree of corresponding pre-load of the automatic valve 41 in the shut-off position, the following modes of functioning result for the automatic valve 41 when the compression spring is blocked i.e., with the blocking valve 20 shut off:

In a first mode of functioning of the compression spring, this excess pressure, upon which the automatic valve 41 will open, is achieved when the piston rod 8 is completely relieved. With the compression spring used for seat backrest setting, this can be the case when the backrest is relieved by a user straightening up while the backrest position is blocked i.e., while the valve 20 is blocked. In this case the automatic valve 41 opens while the blocking valve 20 stays shut, hydraulic oil flowing from the first sectional casing chamber 15 into the second sectional casing chamber 16, whereby the piston 12 is slowly pushed out along with the piston rod 8. The pre-load of the disk 41a of the automatic valve 41 can be selected such that the valve 41 will open while the piston rod 8 has not yet been entirely relieved i.e., while it is still actuated from outside by pressure counter to the direction of piston-rod extension. This is for instance advantageous when automatic extension of the piston rod is to take place with the piston rod still partially loaded in the push-in direction, which may for instance be caused by the residual weight of the backrest in the case of seat backrest setting. This weight is transmitted to the piston rod in the piston-rod push-in direction even when the backrest if relieved.

In a second mode of functioning, any relief of the piston rod 8 and thus of the piston 12 does not yet result in the automatic valve 41 opening. Only when a certain additional setting force is exercised on the compression spring in the piston-rod-8 push-out direction, this additional setting force leads to the force of overcoming being reached and, consequently, to sufficient difference in pressure between the sectional casing chambers 15, 16, which results in the automatic valve 41 opening. In this mode of functioning, the compression spring can nevertheless be set in the direction of extension by a comparatively inferior setting force being exercised. This can for example be used in table-top height adjustment.

In a third mode of functioning, the automatic valve 41 only opens when a comparatively important force of overcoming is exercised in the direction of extension, corresponding for example to twice the force of extension of the compression spring when the blocking valve 20 is open. This is accomplished by correspondingly increased pre-load of the disk 41a of the automatic valve 41. This mode of functioning can be employed for instance in seat backrest adjustment with rows of seats disposed successively one behind the other, whereby a user, who is seated in a row behind a backrest that has been set backwards, is enabled to set this backrest into a less inclined position by exercising a correspondingly great adjusting force in the push-out direction even if the blocking valve 20 is blocked.

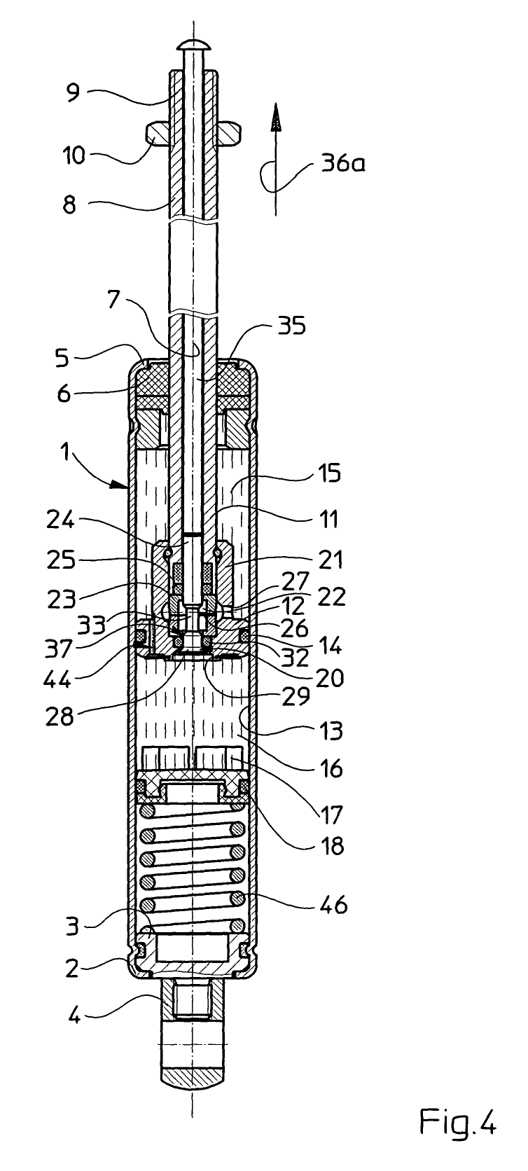

Further embodiments of compression springs are illustrated in FIGS. 4 to 7. Components that correspond to those specified in conjunction with FIGS. 1 to 3 have the same reference numerals and will not be explained in detail once again.

FIG. 4 illustrates a second embodiment of a compression spring. It differs from the first embodiment only in that a helical spring 46 is disposed as a spring element in the chamber 19 in lieu of compressed gas as an energy accumulator. Otherwise the compression spring of FIG. 4 corresponds to the first embodiment.

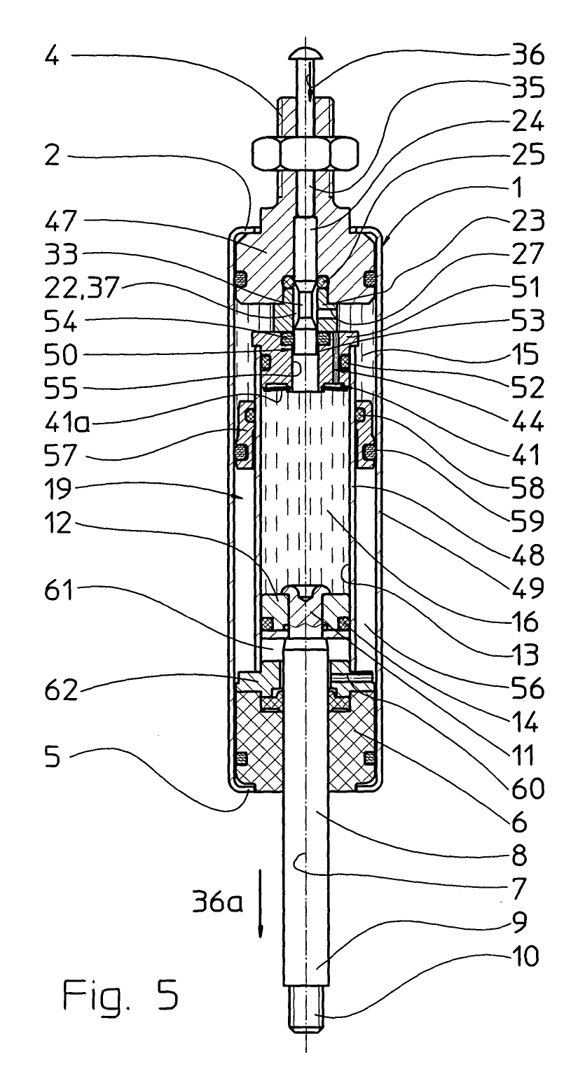

FIG. 5 illustrates a third embodiment of the compression spring. The piston rod 8 and the valve actuation rod 35 are extended from opposite sides of the casing 1. In addition to the guide and seal unit 6 for the piston rod 8 at the end 5 of the compression spring, a second guide and seal unit 47 is fixed for fluid-tight sealing to the opposite end 2 of the casing 1 in the third embodiment, serving for guiding and sealing the valve actuation rod 35 that is displaceable in the casing 1 coaxially of the central longitudinal axis 7 thereof. In this embodiment, the first sectional casing chamber 15 is configured in axial vicinity to the guide and seal unit 47 as an annular chamber that is defined inwards by the bush 23 and the valve body 51 of the blocking valve 50 and moreover by the outside wall of the interior casing cylinder 48.

The piston 12 of the piston rod 8 is guided in an interior casing cylinder 48, which contains the second sectional casing chamber 16 and is disposed coaxially of an exterior casing cylinder 49 that defines the casing 1 outwards. In this embodiment, the piston 12 is not disposed between the two sectional casing chambers 15, 16. In the third embodiment, these two sectional casing chambers 15, 16 are separated by a blocking valve 50 with a valve body 51 that closes the interior casing cylinder 48 on the side turned towards the guide and seal unit 47. A seal 52 tightens between the valve body 51 and the inside wall of the interior casing cylinder 48.

On its end, turned towards the sectional casing chamber 16, the valve pin 24 of this embodiment comprises a pin section with a cylindrical sealing face 53. In the blocking-valve-50 shut-off position, this sealing face 53 rests on an opposite surface 55 of the valve body 51 via a seal 54. The actuation/overflow assembly 37 of the blocking valve 50 is formed by the overflow channel 27, the overflow chamber 22 and—in the open position of the blocking valve 50—by a narrow annular space between the sealing face 53 and the opposite surface 55. Upon insertion of the piston 12 into the second sectional casing chamber 16 in a direction towards the valve body 51, hydraulic oil flows from the second sectional casing chamber 16 through the actuation/overflow assembly 37 into the first sectional casing chamber 15. This insertion takes place against the counterforce produced by compressed gas in a compressed-gas chamber 56.

The compressed-gas chamber 56 is partially configured as an annular chamber between the interior casing cylinder 48 and the exterior casing cylinder 49. Disposed between the first sectional casing chamber 15 and the compressed-gas chamber 56 is a sliding piston ring 57 which, in this embodiment, has the function of the sliding piston 17 of the first embodiment. The sliding piston ring 57 is tightened by a seal 58 towards the outside wall of the interior casing cylinder 48 and by a seal 59 towards the inside wall of the exterior casing cylinder 49. Via a compressed-gas overflow channel 60, this annular sectional chamber of the compressed-gas chamber 56 is connected to a second sectional chamber 61 of the compressed-gas chamber 19 which is equally annular, encircling the piston rod 8 behind the piston 12. The compressed-gas overflow channel 60 is formed in an intermediate body 62 which is formed between the guide and seal unit 6 and the end portion, turned thereto, of the interior casing cylinder 48.

Upon insertion of the piston 12 in the direction towards the valve body 51, the sectional chamber 61 grows and compressed gas flows from the sectional chamber 56 into the sectional chamber 61. Owing to the area ratio of the pressure-loaded surfaces of the piston 12, the force, exercised by the compressed gas on an annular surface of the piston 12 around the piston rod 8 in the piston-rod-8 push-in direction, is less than the force exercised by the compressed gas via the sectional casing chambers 15 and 16 on the full cross-sectional surface of the piston 12 in the piston-rod-8 push-out direction. The net result is a force of extension from the compressed-gas chamber 19 on the piston 12 when the blocking valve 50 is open. Upon insertion of the piston 12, the sliding piston ring 57 is dislocated in the direction towards the intermediate body 62.

If however the piston rod 8 is relieved when the blocking valve 50 is open, it is pushed out of the casing 1 by the net extension force exercised by the compressed gas on the piston 12, with the sliding piston ring 57 being moved in the direction towards the guide and seal unit 47. The compression spring of the third embodiment is also a compression gas spring. If the actuation rod 35 is released, the valve pin 24 is forced into its shut-off position by the pressure that prevails in the sectional casing chamber 16. The piston 12, together with the piston rod 8, is then hydraulically locked and blocked relative to the casing 1.

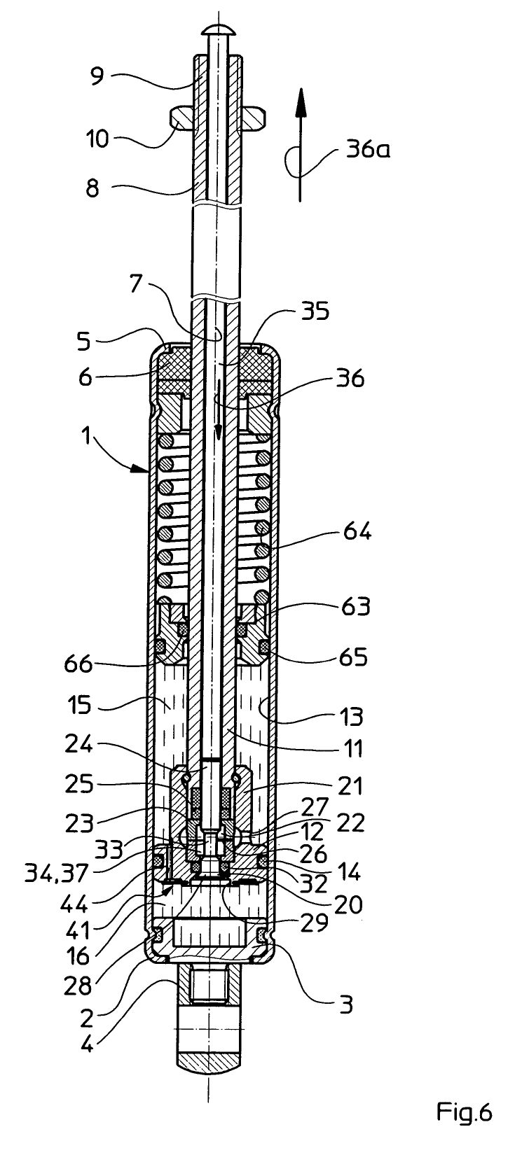

FIG. 6 illustrates a fourth embodiment of a compression spring. It differs from the second embodiment in that a sliding piston ring 63 is provided in this fourth embodiment, replacing the sliding piston that defines the second sectional casing chamber towards a compressed-gas chamber. The sliding piston ring 63 is disposed between the piston rod 8 and the casing 1, fluid-tightly separating the first sectional casing chamber 15 from a helical spring 64 by means of seals 65, 66; the helical spring 64 is disposed coaxially of the central longitudinal axis 7 around the piston rod 8 in vicinity to the guide and seal unit 6. It serves as an energy accumulator of the compression spring of the fourth embodiment.

With the blocking valve 20 open, upon insertion of the piston 12 in the direction towards the bottom 3 of the casing 1, overflow of the hydraulic oil takes place, by way of the actuation/overflow assembly 37, from the second sectional casing chamber 16 into the first sectional casing chamber 15 against the pressure of the helical spring 64, with the sliding piston ring 63 being further displaced in the direction towards the guide and seal unit 6. If however the piston rod 8 is relieved while the blocking valve 20 is open, the piston rod 8 is extended from the casing 1 via the first sectional casing chamber 15, the actuation/overflow assembly 37 and the second sectional casing chamber 16 by the force exercised by the helical spring 64 on the hydraulic oil, with the sliding piston ring 63 being moved towards the bottom 3.

In accordance with the modes of functioning described in conjunction with FIGS. 1 to 3, the piston rod 8, in the locked position, can be adjusted by the action of the automatic valve 41 in the direction of extension when the given pre-load of the disk 41a of the automatic valve 41 is overcome.

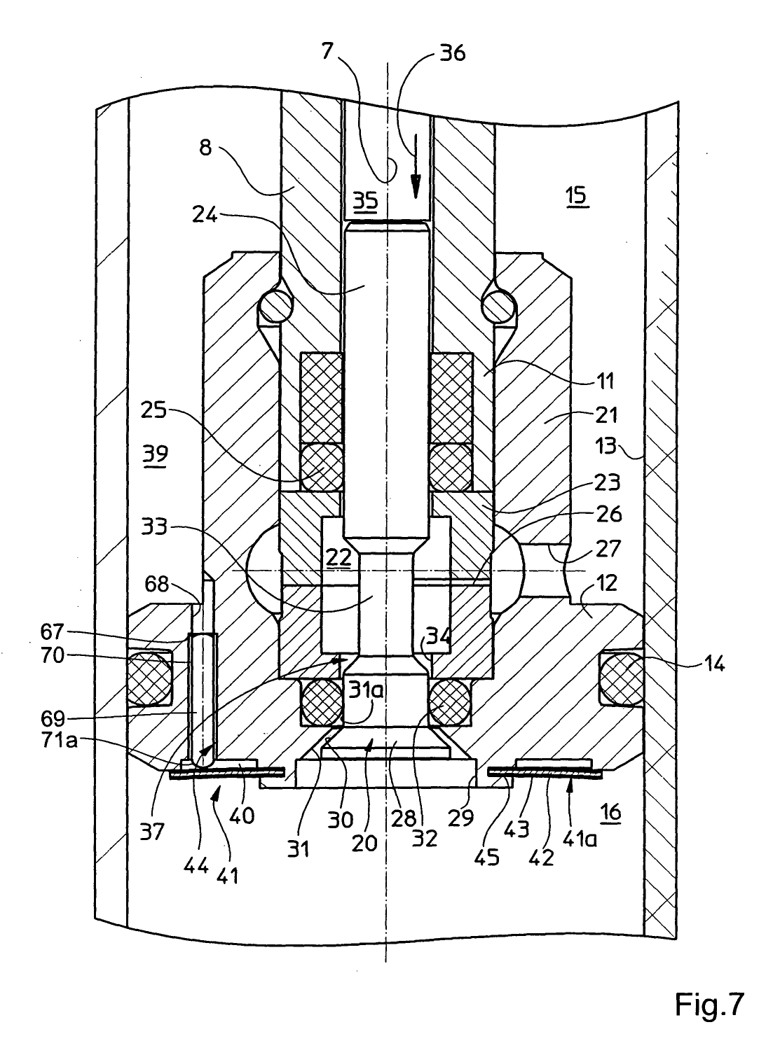

Another embodiment of the compression spring is seen in FIG. 7. It differs from the embodiment according to FIGS. 1 and 3 only by the design of the overflow channel. Instead of the overflow channel 38 of the embodiment according to FIGS. 1 to 3, the design according to FIG. 7 includes an overflow channel 68 that expands stepwise towards the disk 41a by way of a shoulder 67. Retained in the portion of stepwise expansion of the overflow channel 68 is a cylindrical pin 69, the outside diameter of which being only slightly inferior to the inside diameter of the expanded portion of the overflow channel 68. Consequently, an annular channel 70 forms between the outside wall of the cylindrical pin 69 and the inside wall of the overflow channel 68 in the expanded portion; in the non-expanded portion, the annular channel 70 is in flowing connection to the overflow channel 68. An end 71a of the cylindrical pin 69 that is turned towards the disk 41a is convex in design; according to FIG. 7, it rests on the disk 41a in a position when the disk 41a is not lifted off. Fine tuning of the damping effect of the compression spring according to FIG. 7 is accomplished by way of the diameter ratios of the expanded portion of the overflow channel 68 on the one hand and the cylindrical pin 69 on the other, as well as by way of the length of the cylindrical pin 69. The function of the automatic overflow connection 44 and the compression spring according to FIG. 7 corresponds to what has been explained above in conjunction with the compression spring according to FIGS. 1 to 3.

What is claimed is

1. An adjustable-length compression spring, comprising
a casing (1), which is filled with a free-flowing pressure fluid and has a central longitudinal axis (7);
a guide and seal unit (6), which closes a first end (5) of the casing (1);
a piston rod (8), which has an outer end (9) and is sealingly extended through the guide and seal unit (6) out of the first end (5) of the casing (1);
a piston (12), which is connected to the piston rod (8) and sealingly guided in the casing (1);
a pressure-fluid-filled first sectional casing chamber (15), which is unilaterally defined by the piston (12);
an energy accumulator (19; 46; 64) for exercising pressure on the pressure fluid;
a pressure-fluid-filled second sectional casing chamber (16), which is connectable to the first sectional casing chamber (15); and
a controllable valve (20; 50) for interconnection of the sectional casing chambers (15, 16) by an actuation/overflow assembly (37), the valve (20; 50) having a valve pin (24), which is movable from outside the casing (1) into an open position of the controllable valve (20; 50) and into a shut-off position;
wherein an automatic valve (41) for interconnection of the sectional casing chambers (15, 16) by an automatic overflow connection (44), the automatic valve (41) comprising a valve element (41a), which is pre-loaded in a shut-off position such that, in the valve-pin-(24) shut-off position of the controllable valve (20; 50), opening the automatic valve (41) into an open position takes place only when an overcoming force F₁ works between the piston rod (8) and the casing (1) in a piston-rod push-out direction (36a), with
−2F₂<F₁<2F₂
applying to a relationship between the overcoming force F₁ and a push-out force F₂ which, by the pressure of the pressure fluid, works between the piston rod (8) and the casing (1) in the sectional casing chambers (15, 16) in a piston-rod push-out direction (36a) in the open position of the valve pin (24) of the controllable valve (20; 50).

2. A compression spring according to claim 1, wherein the automatic valve (41) is designed such that the force F₁ to F₂ relationship is as follows:
0<F₁<F₂.

3. A compression spring according to claim 1, wherein the automatic valve (41) is designed such that the force F₁ to F₂ relationship is as follows:
−F₂<F₁<0.

4. A compression spring according to claim 1, wherein the valve element (41a) of the automatic valve (41) is a composite body with a substrate layer (42) that is at least unilaterally coated with a non-metal layer (43).

5. A compression spring according to claim 4, wherein the substrate layer (42) of the valve element (41a) is made of metal.

6. A compression spring according to claim 4, wherein the non-metal layer (43) of the valve element (41a) is made of one of the group selected from plastic material and rubber.

7. A compression spring according to claim 1, wherein the valve element (41a) of the automatic valve (41) is an annular disk which is pre-loaded in the shut-off position.

8. A compression spring according to claim 1, wherein the energy accumulator is a compressed-gas chamber (19).

9. A compression spring according to claim 1, wherein the energy accumulator is a helical spring (46; 64).

10. A compression spring according to claim 1, comprising oil as a pressure fluid.

11. A compression spring according to claim 1, comprising an automatic overflow connection (44) which comprises an overflow channel (38) with a cylindrical pin (69) at least by sections inserted therein so that an overflow connection in the form of an annular channel (70) is provided between the outside wall of the cylindrical pin (69) and the inside wall, contiguous thereto, of the overflow channel (38).

12. A compression spring according to claim 2, wherein the automatic valve (41) is designed such that the force F₁ to F₂ relationship is as follows:
0<F₁<0.5F₂.

13. A compression spring according to claim 2, wherein the automatic valve (41) is designed such that the force F₁ to F₂ relationship is as follows:
0<F₁<0.1F₂.

14. A compression spring according to claim 2, wherein the automatic valve (41) is designed such that the force F₁ to F₂ relationship is as follows:
F₁=0.

15. A compression spring according to claim 3, wherein the automatic valve (41) is designed such that the force F₁ to F₂ relationship is as follows:
−0.5F₂<F₁<0.

16. A compression spring according to claim 3, wherein the automatic valve (41) is designed such that the force F₁ to F₂ relationship is as follows:
−0.1 F₂<F₁<0.
